(19) United States
(12) Patent Application Publication
(10) Pub. No.: US 2026/0015170 A1
(43) Pub. Date: Jan. 15, 2026

(54) STORAGE AND RETRIEVAL SYSTEM

(71) Applicant: Ocado Innovation Limited, Hatfield (GB)

(72) Inventors: Toni IBIRONKE, Hatfield (GB); Raghuram SURESH, Hatfield (GB); Martin HEANUE, Hatfield (GB); Sowmyan KESAVAN, Hatfield (GB)

(21) Appl. No.: 19/332,610

(22) Filed: Sep. 18, 2025

Related U.S. Application Data
(63) Continuation of application No. PCT/EP2024/057303, filed on Mar. 19, 2024.

(30) Foreign Application Priority Data
Mar. 21, 2023 (GB) 2304108.0

(51) Int. Cl. B65G 1/06; B65G 1/04

(52) U.S. Cl. CPC B65G 1/065; B65G 1/0464

(57) ABSTRACT

A storage and retrieval system is disclosed, comprising: a grid above a workspace; a plurality of containers located in stacks within the workspace; a plurality of load handling devices arranged to move along the grid and configured to raise and lower the containers to and from the stacks located within the workspace; a terminal disposed within the workspace, the terminal being arranged to receive a transport assembly that is configured to enable one or more of the stacks of containers to be transported away from the workspace; wherein the terminal comprises a docking assembly that is arranged to control the position of the transport assembly within the terminal; wherein the docking assembly comprises one or more alignment devices that are arranged to align the transport assembly relative to the grid above the terminal and a friction reducing surface that is arranged to support the transport assembly within the terminal.

### FIELD OF THE INVENTION

The disclosure herein relates to a storage and retrieval system and method. More specifically but not exclusively, it relates to a storage and retrieval system using stackable containers stored in a workspace located beneath a grid, where the containers, holding objects, are transported using load handling devices travelling on top of the grid. Furthermore, it relates to a range of variations to the system that enables the efficient exchange of containers between handling systems at different locations.

### BACKGROUND

Some commercial and industrial activities require systems that enable the storage and retrieval of a large number of different products. One known type of system for the storage and retrieval of items in multiple product lines involves arranging storage bins or containers in stacks on top of one another, the stacks being arranged in rows. The storage bins or containers are accessed from above, removing the need for aisles between the rows and allowing more containers to be stored in a given space.

Methods of handling containers stacked in rows have been well known for decades. GB2520104A the contents of which are incorporated herein by reference, describes a system in which stacks of containers are arranged within a frame structure. A system of this type is illustrated schematically in FIGS. 1 to 4 of the accompanying drawings. Robotic load handling devices can be controllably moved around the stack on a system of tracks on the upper most surface of the stack.

With these types of systems, there could from time to time be a need to transfer large numbers of storage containers from one system to another one at a different location. One such example is if a company operates multiple fulfilment centres servicing different geographical areas, such as described in GB2533846A. Variable demand may mean that some items are running out of stock at one location, while they are in surplus at another location. It may also be beneficial to receive and put into containers a large quantity of an item at one place, rather than many smaller quantities of the same item at several locations. GB2541487 then describes a system in which such a storage and retrieval system is provided with moving means adapted to move a portion of the stacks of containers from beneath the grid, independently of the remaining stacks of containers, thereby providing an efficient way of transferring large number of containers from a storage system to a vehicle and then from the vehicle into another storage system.

It is against this background that the present invention has been devised.

### SUMMARY OF THE INVENTION

According to a first aspect, there is provided a storage and retrieval system comprising a grid above a workspace, a plurality of containers located in stacks within the workspace, a plurality of load handling devices arranged to move along the grid and configured to raise and lower the containers to and from the stacks located within the workspace, and a terminal disposed within the workspace, the terminal being arranged to receive a transport assembly that is configured to enable one or more of the stacks of containers to be transported away from the workspace. The terminal comprises a docking assembly that is arranged to control the position of the transport assembly within the terminal. The docking assembly comprises one or more alignment devices that are arranged to align the transport assembly relative to the grid above the terminal and a friction reducing surface that is arranged to support the transport assembly within the terminal.

The docking assembly ensures that the transport assembly can be accurately aligned relative to the grid so that the stacks on the transport assembly can be managed by the load handling devices in the same way as the remaining stacks within the workspace. The docking assembly therefore ensures that storage containers can be loaded on to and unloaded from the transport assembly by the load handling devices. In particular, the friction reducing surface provides that a transport assembly supported on the friction reducing surface can be more easily moved within the terminal, with the direction of the movement being influenced by the alignment devices, to thereby ensure that the transport assembly is accurately aligned.

The grid may define grid spaces and each stack of containers may then be disposed beneath a grid space. The load handling devices may be configured to raise and lower containers to and from each stack through the corresponding grid spaces. The storage and retrieval system may further comprise rails or tracks arranged to form the grid and on which the load handling devices are arranged to move. The storage and retrieval system may comprise two substantially perpendicular sets of tracks or rails arranged to form the grid. The storage and retrieval may comprise a first set of substantially parallel rails or tracks and a second set of substantially parallel rails or tracks extending substantially perpendicularly to the first set in a substantially horizontal plane. The storage and retrieval system may further comprise set of uprights, the uprights supporting the tracks, the uprights and tracks together defining a frame structure.

The load handling devices may each comprise a vehicle mounted on wheels, a first set of wheels being arranged to engage with at least two tracks of the first set of tracks, the second set of wheels being arranged to engage with at least two tracks of the second set of tracks, the first set of wheels being independently moveable and driveable with respect to the second set of wheels such that when in motion only one set of wheels is engaged with the grid at any one time thereby enabling movement of the load handling device along the rails to any point on the grid by driving only the set of wheels engaged with the tracks, the load handling devices further comprising means for removing or replacing containers from the stacks.

The terminal may be arranged to allow the load handling devices to raise and lower the containers to and from the stacks located on the transport assembly when received within the terminal. The transport assembly may comprise movement means that allow the transport assembly to move independently relative to the grid when supported by the movement means on a floor surface and the terminal may be arranged such that the movement means do not touch the floor surface when the tracks are supported on the friction reducing surface. The friction reducing surface may comprise a multi-directional transfer surface, and preferably comprises a roller ball transfer surface.

The terminal may further comprise a releasable restraint device that is arranged, when engaged, to hold the transport assembly within the terminal. The restraint device may be arranged to transition from a disengaged configuration to an engaged configuration during movement of a transport assembly into the docking assembly. The restraint device may be arranged to change from an engaged configuration to a disengaged configuration in response to actuation of a user-operable button. The user-operable button may be located externally relative to the terminal.

The terminal may further comprise a sensor that is arranged to detect the presence of a transport assembly within the terminal, and the restraint device may be arranged to transition from the disengaged configuration to the engaged configuration in response to an input from the sensor. The sensor may comprise a proximity sensor that is arranged to detect when a transport assembly is within a predefined distance of an inner surface of the terminal. The proximity sensor may comprise a contact switch that is arranged to be contacted by a transport assembly when the transport assembly is within a predefined distance of the inner surface of the terminal.

The restraint device may be arranged to hold the transport assembly against an inner surface of the terminal when in the engaged state. The terminal may comprise an opening arranged to allow the transport assembly to move into and out of the terminal and the inner surface of the terminal may then be opposite to the opening. The terminal may comprise a door that is arranged to cover the opening. The retainer device may be further arranged to move the transport assembly towards an inner surface of the terminal.

The grid may define a plurality of grid spaces and each stack of containers may then be disposed beneath a grid space. The terminal may then comprise one or more access channels, each access channel being disposed beneath a corresponding grid space and being arranged to allow the load handling devices to raise and lower storage containers into the terminal. The alignment devices of the docking assembly may be arranged to align the transport assembly within the terminal such that the one or more access channels of the terminal are aligned with container receiving portions of the transport assembly. Each access channel may comprise container guide elements that are arranged to guide containers into and out of the terminal through the access channel. The alignment devices may be arranged to align the transport assembly relative to the container guide elements of the terminal. The container guide elements of each access channel may be disposed at the periphery of the corresponding grid space and extend downward towards the dock assembly. The container guide elements of each access channel may be disposed adjacent to one or more corners of the corresponding grid spaces and comprise a container guide rail that is arranged to channel a corresponding corner of a storage container through the access channel.

The terminal may comprise a chamber that is arranged to receive a transport assembly and within which the docking assembly is located. The chamber may be arranged to enclose the docking assembly and any transport assembly that is docked within the terminal. The chamber may further comprise an opening through which a transport assembly can move into and out of the terminal and a door that is arranged to cover the opening. The opening may be arranged to be adjacent to the outer end of the docking assembly such that a transport assembly moving into the terminal through the opening enters the docking assembly.

The terminal may comprise a lock mechanism that is configured to lock the door, one or more lifting device sensors that are configured to detect when a container-lifting device of a load handling device is within the terminal, and a lock controller that is configured to engage and disengage the lock mechanism in response to outputs from the lifting device sensors.

The terminal may comprise movable bridging elements that are configured to move between a first position and a second position, wherein the bridging elements are arranged, when in the first position, to extend at least partially between an access channel of the terminal and a receiving portion of a transport assembly that is disposed within the terminal and, when in the second position, to be retracted away from the first position. The bridging elements may be arranged to guide storage containers during movement between the access channel of the terminal and a receiving portion of a transport assembly. The bridging elements may be arranged, when in the first position, to extend between a lower end of the access channel and an upper end of the receiving portion of a transport assembly that is docked within the terminal. The bridging elements may be arranged such that, when in the first position, the bridging elements are aligned with and extend between the guide elements of the access channel and the receiving elements of the receiving portion.

The alignment device may comprise a first alignment device provided towards a first side of the docking assembly and a second alignment device provided towards a second side of the docking assembly, wherein the second side is opposite and substantially parallel to the first side. The terminal may comprise an opening arranged to allow the vehicle to move into and out of the terminal, and the first side and second side may then be substantially perpendicular to the opening of the terminal. The alignment devices may be arranged such that, during movement of a transport assembly into the docking assembly, the first alignment device contacts a first side of the transport assembly and the second alignment device contacts an opposite, second side of the transport assembly. The first and second alignment devices may be arranged to funnel a transport assembly into an aligned position during movement of the transport assembly into the docking assembly. The first and second alignment devices may be arranged such that the separation between them tapers.

Each of the alignment devices may comprise one or more revolving guide elements that are arranged to contact a side surface of a transport assembly and rotate whilst guiding the transport assembly into the terminal. Each of the alignment devices may comprise a guide rail that extends from the outer end of the docking assembly to the inner end of the docking assembly. Each of the alignment devices may further comprise a plurality of revolving guide elements mounted to the guide rail, with each revolving guide element being arranged to rotate around a substantially vertical axis.

The docking assembly may comprise a ramp device arranged to raise a transport assembly on to the friction reducing surface during movement of the transport assembly into the docking assembly. The ramp device may comprise one or more rolling elements that are arranged to contact an under surface of the transport assembly during movement of the transport assembly into and out of the docking assembly and to cause the transport assembly to rise up as the transport assembly moves into the docking assembly. The rolling elements may be arranged such that the uppermost surface of the rolling elements define a slope suitable to cause a transport assembly to rise up or descend when rolling over the rolling elements. The one or more rolling elements may also be arranged to cause the transport assembly to descend as the transport assembly moves out of the docking assembly. The ramp device may comprise one or more ramp rails and a plurality of rolling elements mounted to each ramp rail, each rolling element being arranged to rotate around a substantially horizontal axis. The ramp device may be disposed adjacent to an outer end of the friction reducing surface and arranged such that they are substantially parallel with the alignment devices

The transport assembly may comprise a base and a body supported on the base, the body comprising one or more receiving portions, each of the receiving portions being configured to receive and retain a stack of containers. The base of the transport assembly may comprise an under surface that is arranged to contact the friction reducing surface of the docking assembly when the transport assembly is within the terminal such that the transport assembly is supported on the friction reducing surface. The under surface is preferably flat and smooth to ensure that the transport assembly can be moved easily when the under surface is in contact with the friction reducing surface.

The transport assembly may further comprise movement means that allow the transport assembly to move independently relative to the grid. The movement means may be mounted to the base. The transport assembly may be arranged such that, when not within the terminal, the transport assembly is supported by the movement means in order to enable independent movement of the transport assembly. Alternatively, the storage and retrieval system may further comprise a separate transport vehicle that is arranged to carry the transport assembly, the transport vehicle comprising movement means that allow the transport vehicle to move independently relative to the grid and the transport assembly.

The body may comprise a framework that defines the one or more receiving portions, the framework being attached to an upper surface of the base. The or each receiving portion may comprise container receiving elements that are arranged to guide containers into and out of the receiving portion and to restrain a stack of containers within the receiving portion. The alignment devices of the terminal may be arranged to align the transport assembly such that the container receiving elements of the or each receiving portion are aligned with container guide elements of a corresponding access channel of the terminal. The or each receiving portion may comprise an access port through which storage containers are inserted into and removed from the receiving portion. Each access port may comprise an opening at the top of the corresponding receiving portion through which storage containers are lowered to and lifted away from a stack of containers within the receiving portion. The alignment devices of the docking assembly may be arranged to align the transport assembly within the terminal such that each access channel of the terminal is aligned with a corresponding access port of a receiving portion of the transport assembly. The grid may define a plurality of grid spaces, each stack of containers being disposed beneath a grid space, and the alignment devices of the docking assembly may then be arranged to align an access port of each of the receiving portions of the vehicle with a corresponding grid space.

According to a second aspect there is provided a transport assembly that is configured to enable one or more stacks of containers to be transported, the transport assembly comprising a base and a body supported on the base. The body comprises one or more receiving portions, each of the receiving portions being configured to receive and retain a stack of containers.

The transport assembly may further comprise movement means that allow the transport assembly to move independently. The movement means may be mounted to the base.

The body may comprise a framework that defines the one or more receiving portions, the framework being attached to an upper surface of the base. The or each receiving portion may comprise container receiving elements that are arranged to guide containers into and out of the receiving portion and to restrain a stack of containers within the receiving portion. The or each receiving portion may comprise an access port through which storage containers are inserted into and removed from the receiving portion. Each access port may comprise an opening at the top of the corresponding receiving portion through which storage containers are lowered to and lifted away from a stack of containers within the receiving portion.

The container receiving elements of each receiving portion may be disposed at the periphery of the receiving portion and extend downward towards the base. The container receiving elements of each receiving portion may be disposed adjacent to one or more corners of the corresponding receiving portion and comprise a container receiving rail that is arranged to guide containers into and out of the receiving portion. The container receiving elements may each comprise a substantially vertical, elongate container receiving rail having a substantially L-shaped cross section such that the corner of a storage container can be positioned within the corner defined by the container receiving rail. The access port of each receiving portion may comprise a space defined between the upper ends of the container receiving elements that is shaped to receive a storage container.

According to a third aspect there is provided a storage and retrieval system comprising a grid above a workspace, a plurality of containers located in stacks within the workspace, a plurality of load handling devices arranged to move along the grid and configured to raise and lower the containers to and from the stacks located within the workspace, and a terminal disposed within the workspace, the terminal being arranged to receive a transport assembly that is configured to enable one or more of the stacks of containers to be transported away from the workspace. The terminal comprises a docking assembly that is arranged to control the position of the transport assembly within the terminal, and a chamber that is arranged to receive a transport assembly and within which the docking assembly is located.

The chamber comprises an opening through which a transport assembly can move into and out of the terminal, a door that is arranged to cover the opening, a lock mechanism that is configured to lock the door, one or more sensors that are configured to detect when a container-lifting device of a load handling device is within the terminal, and a lock controller that is configured to engage and disengage the lock mechanism in response to outputs from the lifting device sensors.

The chamber may be arranged to enclose the docking assembly and any transport assembly that is docked within the terminal. The opening may be arranged to be adjacent to the outer end of the docking assembly such that a transport assembly moving into the terminal through the opening enters the docking assembly. The docking assembly may comprise one or more alignment devices that are arranged to align the transport assembly relative to the grid above the terminal

According to a fourth aspect there is provided a storage and retrieval system comprising a grid above a workspace, a plurality of containers located in stacks within the workspace, a plurality of load handling devices arranged to move along the grid and configured to raise and lower the containers to and from the stacks located within the workspace, and a terminal disposed within the workspace, the terminal being arranged to receive a transport assembly that is configured to enable one or more of the stacks of containers to be transported away from the workspace. The terminal comprises a docking assembly that is arranged to control the position of the transport assembly within the terminal, and one or more movable bridging elements that are configured to move between a first position and a second position, wherein the bridging elements are arranged, when in the first position, to extend at least partially between an access channel of the terminal and a receiving portion of a transport assembly that is disposed within the terminal and, when in the second position, to be retracted away from the first position. The transport assembly may comprise one or more receiving portions, each of the receiving portions being configured to receive and retain a stack of containers.

The bridging elements may be arranged to guide storage containers during movement between the access channel of the terminal and a receiving portion of a transport assembly. The bridging elements may be arranged, when in the first position, to extend between a lower end of the access channel and an upper end of the receiving portion of a transport assembly that is docked within the terminal. The bridging elements may be arranged such that, when in the first position, the bridging elements are aligned with and extend between the guide elements of the access channel and the receiving elements of the receiving portion.

The grid may define a plurality of grid spaces and each stack of containers may be disposed beneath a grid space. The terminal may then comprise one or more access channels, each access channel being disposed beneath a corresponding grid space and being arranged to allow the load handling devices to raise and lower storage containers into the terminal.

The docking assembly may comprise one or more alignment devices that are arranged to align the transport assembly relative to the grid above the terminal. The alignment devices of the docking assembly may be arranged to align the transport assembly within the terminal such that the one or more access channels of the terminal are aligned with container receiving portions of the transport assembly. Each access channel may comprise container guide elements that are arranged to guide containers into and out of the terminal through the access channel. The alignment devices may be arranged to align the transport assembly relative to the container guide elements of the terminal. The container guide elements of each access channel may be disposed at the periphery of the corresponding grid space and extend downward towards the dock assembly.

According to a fifth aspect there is provided a storage and retrieval system comprising a grid above a workspace, a plurality of containers located in stacks within the workspace, a plurality of load handling devices arranged to move along the grid and configured to raise and lower the containers to and from the stacks located within the workspace, and a terminal disposed within the workspace, the terminal being arranged to receive a transport assembly that is configured to enable one or more of the stacks of containers to be transported away from the workspace. The terminal comprises a docking assembly that is arranged to control the position of the transport assembly within the terminal, and a releasable restraint device that is arranged, when engaged, to hold the transport assembly within the terminal. The docking assembly may comprise one or more alignment devices that are arranged to align the transport assembly relative to the grid above the terminal. The docking assembly may comprise a friction reducing surface that is arranged to support the transport assembly within the terminal.

The restraint device may be arranged to transition from a disengaged configuration to an engaged configuration during movement of a transport assembly into the docking assembly. The restraint device may be arranged to change from an engaged configuration to a disengaged configuration in response to actuation of a user-operable button.

The terminal may further comprise a sensor that is arranged to detect the presence of a transport assembly within the terminal, and the restraint device may then be arranged to transition from the disengaged configuration to the engaged configuration in response to an input from the sensor. The sensor may comprise a proximity sensor that is arranged to detect when a transport assembly is within a predefined distance of an inner surface of the terminal. The proximity sensor may comprise a contact switch that is arranged to be contacted by a transport assembly when the transport assembly is within a predefined distance of the inner surface of the terminal.

The restraint device may be arranged to hold the transport assembly against an inner surface of the terminal when in the engaged state. The terminal may comprise an opening arranged to allow the transport assembly to move into and out of the terminal and the inner surface of the terminal is opposite to the opening.

Other variations and advantages will become apparent from the following description.

### BRIEF DESCRIPTION OF THE DRAWINGS

These and other aspects of the invention will now be described, by way of example only, and with reference to the accompanying drawings, in which:

FIG. 1 is a schematic perspective view of a frame structure for housing a plurality of stacks of bins in a known storage system;

FIG. 2 is a schematic plan view of part of the frame structure of FIG. 1;

FIG. 3a is a schematic perspective view of one form of load handling device for use with the frame structure of FIGS. 1 and 2;

FIG. 3b is a schematic perspective cut away view of the load handling device of FIG. 3a showing a container-receiving recess of the load handling device;

FIG. 3c is a schematic perspective cut away view of the load handling device of FIG. 3a showing a container accommodated within the container-receiving recess of the load handling device;

FIG. 4 is a schematic perspective view of a known storage system comprising a plurality of load handler devices of the type shown in FIGS. 3(a), 3(b) and 3(c), installed on the frame structure of FIGS. 1 and 2;

FIG. 5 is a schematic perspective view of a terminal disposed beneath a portion of the grid of a known storage system with a transport assembly docked within the terminal;

FIG. 6a is a schematic perspective view of the terminal of FIG. 5 in isolation;

FIG. 6b is a schematic top-down view of the terminal of FIG. 6a;

FIG. 7a is a schematic perspective view of a docking assembly of the terminal of FIG. 5 in isolation;

FIG. 7b is a schematic top-down view of the docking assembly of FIG. 7a;

FIG. 7c is a schematic side-on cross-sectional view of the docking assembly of FIG. 7a;

FIG. 8a is a schematic perspective view of a transport assembly that is suitable for use with the terminal of FIG. 5;

FIG. 8b is a schematic bottom-up view of the transport assembly of FIG. 8a;

FIG. 8c is a schematic top-down view of the transport assembly of FIG. 8a;

FIG. 9a is a schematic front-on view of an alternative arrangement of a terminal that further comprises movable bridging elements, the moveable bridging elements being in a first position;

FIG. 9b is a schematic front-on view of the terminal of FIG. 9a in which the moveable bridging elements are in a second position;

FIG. 10a is a schematic front-on view of a further alternative arrangement of a terminal that further comprises movable bridging elements, the moveable bridging elements being in a first position;

FIG. 10b is a schematic front-on view of the terminal of FIG. 10a in which the moveable bridging elements are in a second position;

FIG. 11a is a schematic front-on view of a yet further alternative arrangement of a terminal that further comprises movable bridging elements, the moveable bridging elements being in a first position; and

FIG. 11b is a schematic front-on view of the terminal of FIG. 11a in which the moveable bridging elements are in a second position.

In the figures, like features are denoted by like reference signs where appropriate.

### DETAILED DESCRIPTION

The following embodiments represent preferred examples of how the invention may be practiced, but they are not necessarily the only examples of how this could be achieved. These examples are described in sufficient detail to enable those skilled in the art to practice the invention. Other examples may be utilised and structural changes may be made without departing from the scope of the invention as defined in the appended claims. Moreover, direction references and any other terms having an implied orientation are given by way of example to aid the reader's understanding of the particular examples described herein. They should not be read to be requirements or limitations, particularly as to the position, orientation, or use of the invention unless specifically set forth in the appended claims. Similarly, connection references (e.g., attached, coupled, connected, joined, secured, and the like) are to be construed broadly and may include intermediate members between a connection of elements and relative movement between elements. As such, connection references do not necessarily infer that two elements are directly connected and in fixed relation to each other, unless specifically set forth in the appended claims. Similarly, wording such as “movement in the n-direction” and any comparable wording, where n is one of x, y or z, is intended to mean movement substantially along or parallel to the n-axis, in either direction (i.e., towards the positive end of the n-axis or towards the negative end of the n-axis).

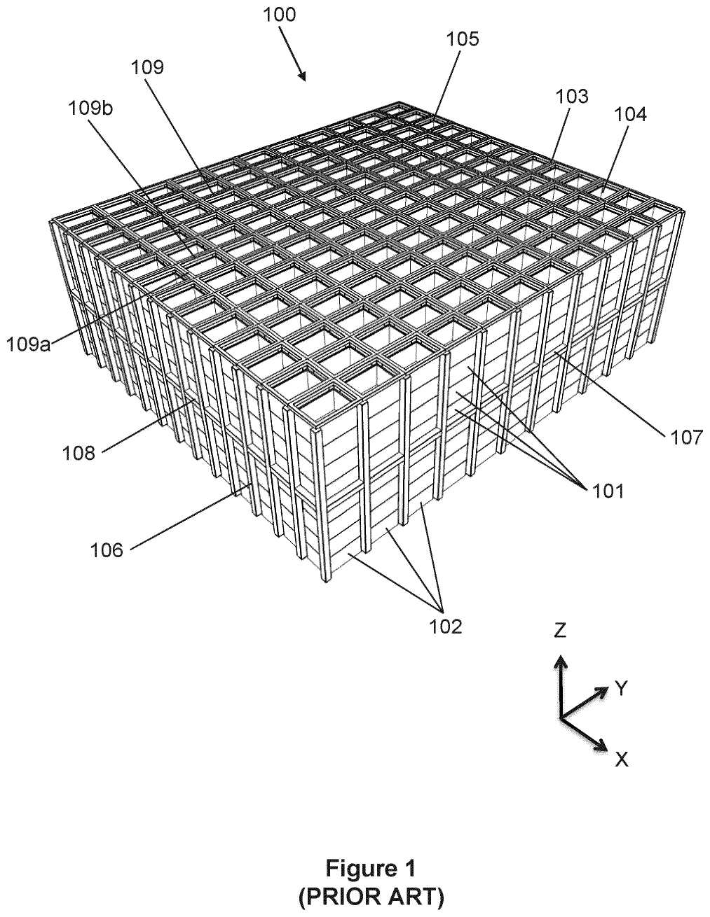

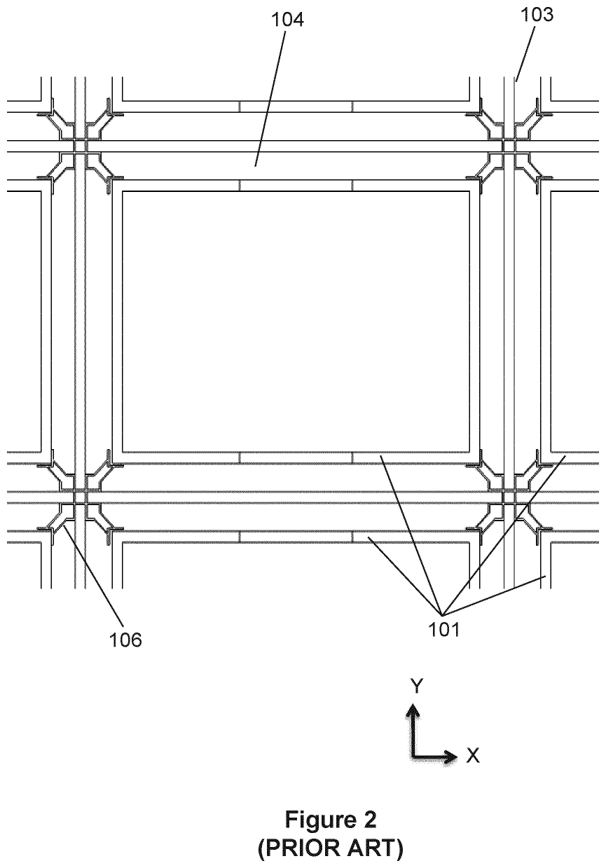

FIG. 1 is a schematic perspective view of a known storage system 100 comprising a plurality of stacks 102 of storage containers 101 stored in a workspace located beneath a grid 103, and FIG. 2 is a top-down view showing a single stack 102 of storage containers 101 arranged beneath the grid 103. As shown in FIG. 1, the stackable storage containers 101, known as bins, are stacked on top of one another to form the stacks 102. The grid 103 defines grid spaces 104 and each stack 102 of containers 101 is disposed beneath and aligned with a grid space 104. Each storage container 101 typically holds a plurality of product items (not shown), and the product items within a storage container 101 may be identical, or may be of different product types depending on the application.

The grid 103 is part of a frame structure 105 that comprises a plurality of upright members 106 that support horizontal members 107, 108. A first set of parallel horizontal members 107 is arranged perpendicularly to a second set of parallel horizontal members 108 to form a plurality of horizontal grid structures supported by the upright members 106. The members 106, 107, 108 are typically manufactured from metal. The containers 101 are stacked between the members 106, 107, 108 of the frame structure 105, so that the frame structure 105 guards against horizontal movement of the stacks 102 of containers 101, and guides vertical movement of the containers 101.

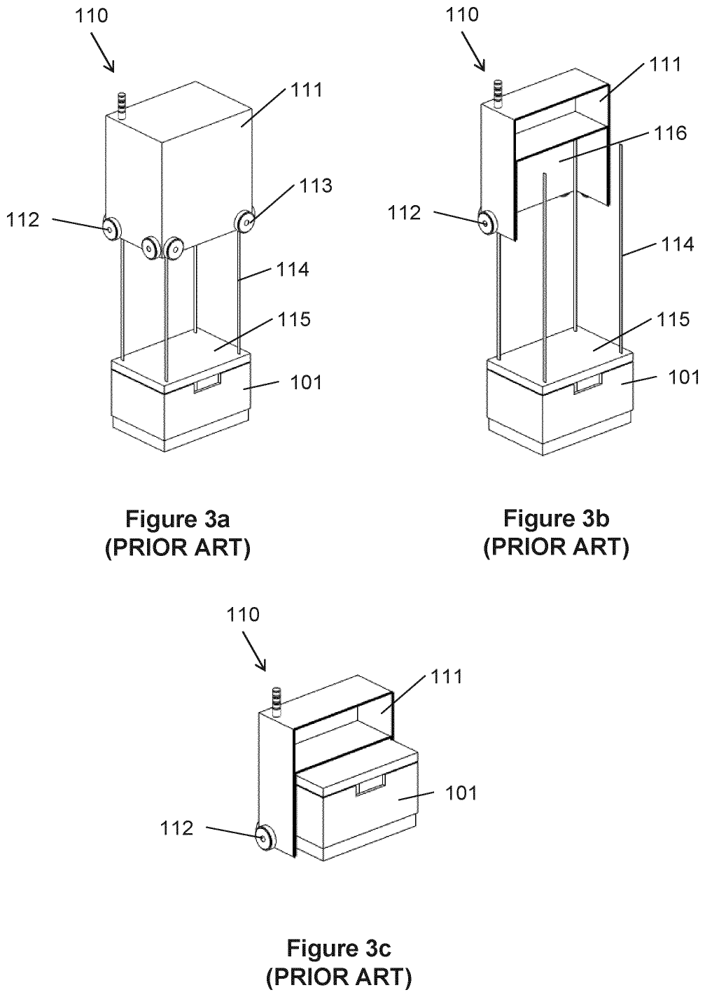

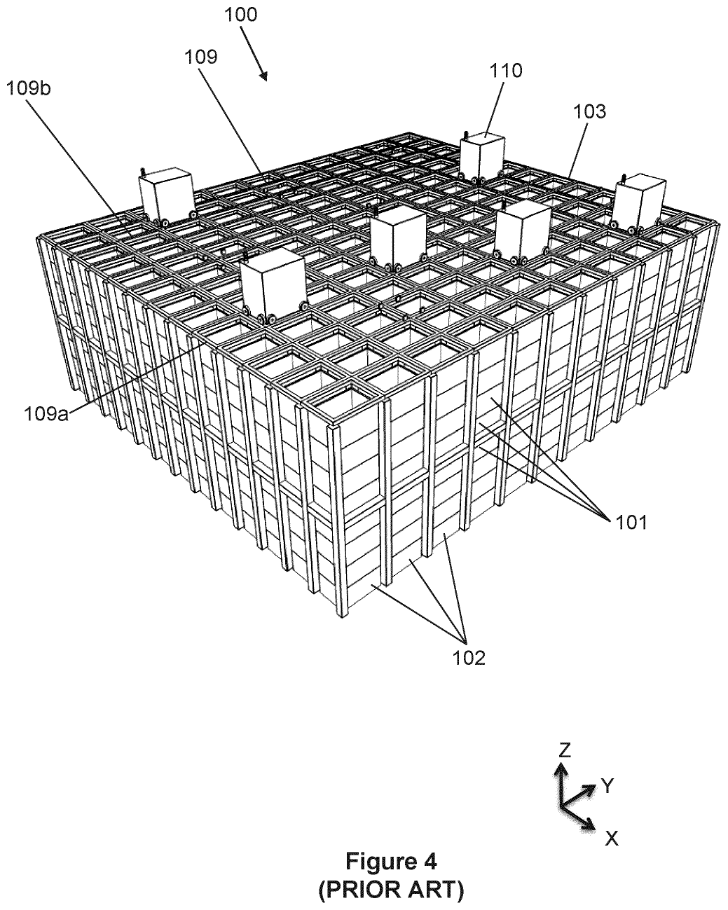

The top level of the frame structure 105 then comprises the grid 103. The grid 103 comprises rails or tracks 109 supported on the upright members 106 and arranged in a grid pattern above the stacks 102. Referring additionally to FIGS. 3a, 3b, 3c and 4, the tracks 109 support a plurality of load handling devices 110. A first set 109a of parallel tracks 109 guide movement of the load handling devices 110 in a first direction (X) across the top of the grid 103, and a second set 109b of parallel tracks 109, arranged perpendicular to the first set 109a, guide movement of the load handling devices 110 in a second direction (Y), perpendicular to the first direction. In this way, the tracks 109 allow movement of the load handling devices 110 in two dimensions in the X-Y plane, so that a load handling device 110 can be moved into position above any of the stacks 102.

As shown in FIGS. 3a, 3b and 3c, each load handling device 110 comprises a vehicle 111 which is arranged to travel in the X and Y directions on the tracks 109 of the grid 103, above the stacks 102. A first set of wheels 112, consisting of a pair of wheels 112 on the front of the vehicle 111 and a pair of wheels 112 on the back of the vehicle 111, are arranged to engage with two adjacent tracks of the first set 109a of tracks 109. Similarly, a second set of wheels 113, consisting of a pair of wheels 113 on each side of the vehicle 111, are arranged to engage with two adjacent tracks of the second set 109b of tracks 109. Each set of wheels 112, 113 can be lifted and lowered, so that either the first set of wheels 112 or the second set of wheels 113 is engaged with the respective set of tracks 109a, 109b at any one time.

When the first set of wheels 112 is engaged with the first set of tracks 109a and the second set of wheels 113 are lifted clear from the tracks 109, the wheels 112 can be driven, by way of a drive mechanism (not shown) housed in the vehicle 111, to move the load handling device 110 in the X direction. To move the load handling device 110 in the Y direction, the first set of wheels 112 are lifted clear of the tracks 109, and the second set of wheels 113 are lowered into engagement with the second set of tracks 109a. The drive mechanism can then be used to drive the second set of wheels 113 to achieve movement in the Y direction. In this way, one or more load handling devices 110 can move around on the grid 103 above the stacks 102 under the control of a central control system (not shown).

FIG. 4 shows a storage system 100 as described above with reference to FIGS. 1 and 2, the system having a plurality of load handling devices 110 active on the grid 103 above the stacks 102. Each load handling device 110 comprises a container-lifting device 114, 115 configured to raise and lower containers 101. In the example illustrated in FIGS. 3a, 3b and 3c, the container-lifting device 114, 115 comprises winch cables or tethers 114 that are arranged to extend in a vertical direction, whose upper ends are attached to the vehicle 111 and whose lower ends are connected to a releasable container-engaging assembly 115. The container-engaging assembly 115 comprises engaging devices (which may, for example, be provided at the corners of the assembly 115) configured to releasably engage with features of the containers 101. For instance, the containers 101 may be provided with one or more apertures in their upper sides with which the engaging devices can engage. Alternatively or additionally, the engaging devices may be configured to hook under rims or lips of the containers 101, and/or to clamp or grasp the containers 101. The cables 114 may be wound up or down to raise or lower the container-engaging assembly 115, as required. One or more motors or other means may be provided to effect or control the winding up or down of the cables 114. The cables 114 and the one or more motors may together form a raising and lowering assembly configured to raise and lower the container-engaging assembly 115.

The wheels 112, 113 are arranged around the periphery of a cavity or recess, known as a container-receiving recess 116, provided by the vehicle 111. The recess is sized to accommodate the container 101 when it is lifted by the container-lifting device, as shown in FIG. 3c. When in the recess 116, the container 101 is lifted clear of the tracks 109 beneath, so that the vehicle 111 can move laterally to a different location. On reaching the target location, for example another stack, an access point in the storage system or a conveyor belt, the container 101 can be lowered from the container receiving recess 116 and released from the container-lifting device. In this way, each load handling device 110 is able to lift a storage container 101 from beneath the grid 103 of a storage system of the type shown in FIG. 1, and transport the storage container 101 to another location within the system.

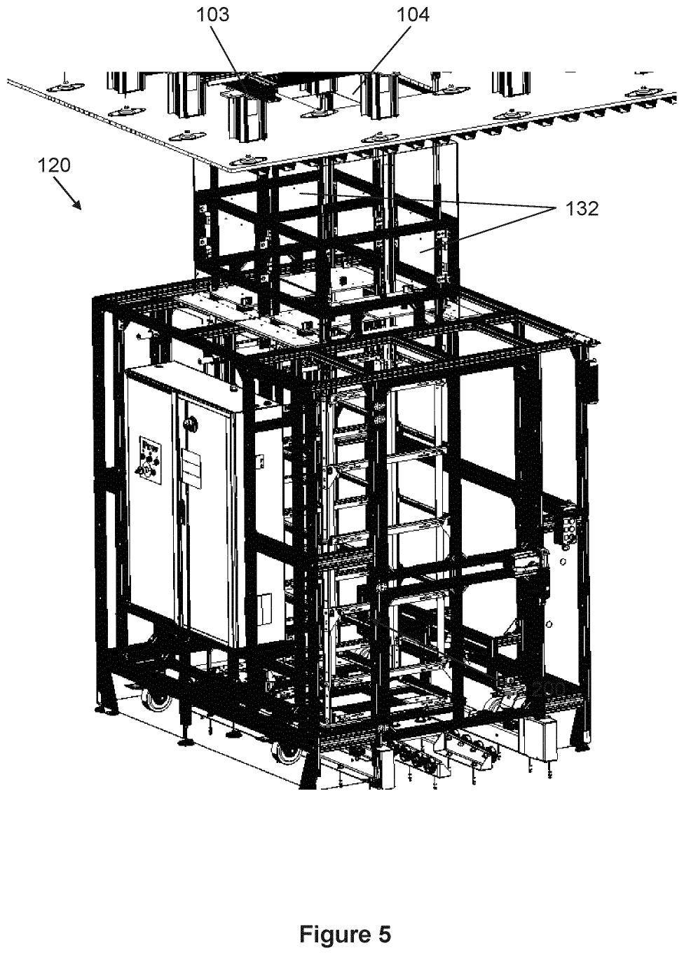

FIG. 5 then shows an arrangement of the stored system 100 shown in FIGS. 1 and 4 in which the system 100 further comprises a terminal or docking station 120 disposed beneath a portion of the grid 103. The terminal 120 is arranged to receive a transport assembly 200, with the transport assembly 200 being independently movable relative to the grid 103 and being configured to enable a portion of the stacks 102 of containers 101 to be transported away from the workspace beneath grid 103. The terminal 120 is then arranged to allow the load handling devices 110 operating on the grid 103 to raise and lower the containers 101 to and from stacks 102 located on a transport assembly 200 that is received within the terminal 120.

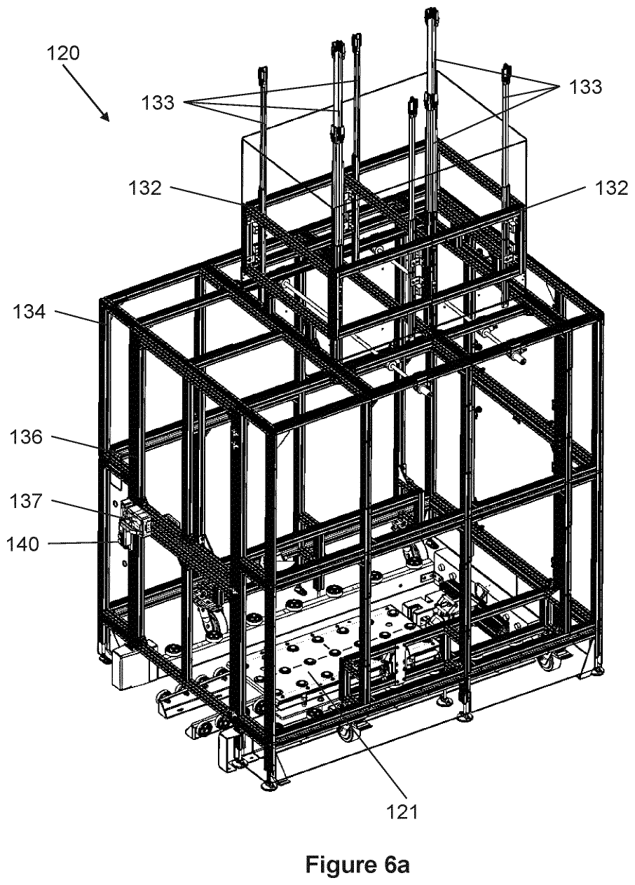

Whilst FIG. 5 shows a transport assembly 200 docked within the terminal 120, FIGS. 6a and 6b then show the terminal 120 in isolation, without a transport assembly docked within the terminal 120. The terminal 120 comprises a docking assembly 121 into which the transport assembly 200 is inserted when received within the terminal 120 and that is arranged to control the position of the transport assembly 200 within the terminal 120.

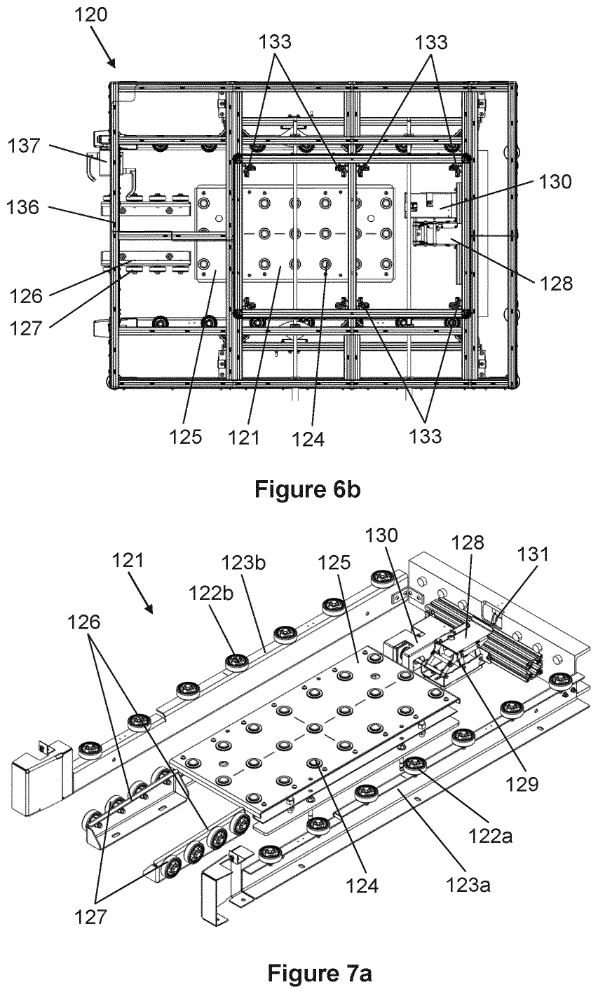

FIGS. 7a, 7b and 7c show the docking assembly 121 in isolation. The docking assembly 121 comprises two or more alignment devices 122a, 122b, 123a, 123b that are arranged to align a transport assembly 200 relative to the grid 103 above the terminal 120 and a friction reducing surface 124, 125 that is arranged to support the transport assembly 200 within the terminal 120. The friction reducing surface 124, 125 provides that a transport assembly 200 supported on the friction reducing surface 124, 125 can be more easily moved within the terminal 120, with the direction of the movement being influenced by the alignment devices 122a, 122b, 123a, 123b. In particular, when a transport assembly 200 is loaded with a number of storage containers 101, the overall weight of the transport assembly 200 can be significant, making movement of the transport assembly difficult. This can be especially problematic when trying to make relatively small adjustments to the position of the transport assembly 200 that are required in order to ensure that the transport assembly 200 is accurately aligned relative to the grid 103.

In the arrangement illustrated in FIGS. 7a, 7b and 7c, the friction reducing surface 124, 125 comprises a roller ball transfer surface. The roller ball transfer surface is arranged to contact an under surface of the transport assembly 200 during movement of the transport assembly 200 into the docking assembly 121 and thereby support the transport assembly 200 when within the docking assembly 121. The roller ball transfer surface comprises a plurality of ball transfer units 124 mounted to a raised surface 125. Each ball transfer unit 124 comprises a load-bearing spherical ball mounted into a restraining fixture. The mounting of the ball within the fixture is such that a portion of the ball projects upwardly from the fixture and allows for omnidirectional rolling of the ball relative to the fixture. In alternative arrangements, the friction reducing surface 124, 125 could comprise any other form of multi-directional transfer surface.

The docking assembly 121 then further comprises a ramp device 126, 127 arranged to raise a transport assembly 200 on to the friction reducing surface 124, 125 during movement of the transport assembly 200 into the docking assembly 120. In the arrangement illustrated in FIGS. 7a, 7b and 7c, the ramp device 126, 127 comprises one or more rolling elements 127 that are arranged to contact an under surface of the transport assembly 200 during movement of the transport assembly 200 into and out of the docking assembly 120, and to cause the transport assembly 200 to rise up (i.e. from a floor surface) as the transport assembly 200 moves into the docking assembly 120. The one or more rolling elements 127 also cause the transport assembly 200 to descend as the transport assembly 200 moves out of the docking assembly 120.

In the illustrated arrangement, the ramp device 126, 127 comprises a pair of ramp rails 126 disposed adjacent to an outer end of the friction reducing surface 124, 125 (i.e. the end of the friction reducing surface 124, 125 that is toward the outer end of the docking assembly 120) and arranged such that they are substantially parallel with the alignment devices 122a, 122b, 123a, 123b. A plurality of rolling elements 127 are then mounted to each ramp rail 126, with each rolling element 127 being arranged to rotate around a substantially horizontal axis (i.e. in a substantially vertical plane). On each ramp rail 126, the rolling elements 127 are arranged such that the uppermost surface of the rolling elements 127 define a slope(S) suitable to cause a transport assembly 200 to rise up or descend when rolling over the rolling element 127. In the illustrated arrangement, each rolling element 127 comprises a wheel mounted to the corresponding ramp rail. However, in an alternative arrangement, each rolling element could comprise a roller rather than a wheel.

In the arrangement illustrated in FIGS. 7a, 7b and 7c, the alignment devices 122a, 122b, 123a, 123b are then disposed on opposite sides relative to the friction reducing surface 124, 125. Specifically, a first alignment device 122a, 123a is provided towards a first side of the docking assembly 121 and a second alignment device 122b, 123b is provided towards a second side of the docking assembly 121, wherein the second side is opposite and substantially parallel to the first side. The alignment devices 122a, 122b, 123a, 123b are arranged such that, during movement of a transport assembly 200 into the docking assembly 121, the first alignment device 122a, 123a contacts a first side of the transport assembly 200 and the second alignment device 122b, 123b contacts an opposite, second side of the transport assembly 200, thereby guiding movement of the transport assembly 200.

In the arrangement illustrated in FIGS. 7a, 7b and 7c, the first and second alignment devices 122a, 122b, 123a, 123b are arranged to funnel a transport assembly 200 into an aligned position during movement of the transport assembly 200 into the docking assembly 121. To do so, the first and second alignment devices 122a, 122b, 123a, 123b are arranged such that the separation between them tapers. Specifically, the separation (Dₒ) between the first and second alignment devices 122a, 122b, 123a, 123b is larger at an outer end of the docking assembly 121 then the separation (Dₗ) at an inner end of the docking assembly 121. The larger separation at the outer end (Dₗ) makes it easier to align a transport assembly 200 with the open end, whilst the tapering of the separation then ensures that the transport assembly 200 becomes more accurately aligned with the grid 103 as it moves towards the inner end of the docking assembly 121. In particular, it is preferable that at the inner end of the docking assembly the separation (Dₗ) between the first and second alignment devices 122a, 122b, 123a, 123b is approximately equal to the width of the transport assembly 200.

In the arrangement illustrated in FIGS. 7a, 7b and 7c, each of the alignment devices comprise one or more revolving guide elements 122a, 122b that are arranged to contact a side surface of the transport assembly 200 and rotate whilst guiding the transport assembly 200 into the terminal 120. In particular, in the illustrated arrangement each of the alignment devices comprises a guide rail 123a, 123b that extends from the outer end of the docking assembly 121 to the inner end of the docking assembly 121. A plurality of revolving guide elements 122a, 122b are then mounted to each guide rail 123a, 123b, with each revolving guide element 122a, 122b being arranged to rotate around a substantially vertical axis (i.e. in a substantially horizontal plane). In the illustrated arrangement, each revolving guide element 122a, 122b comprises a guide wheel mounted to a corresponding guide rail 123a, 123b. However, in an alternative arrangement, each revolving guide element 122a, 122b could comprise a roller rather than a wheel.

In a yet further alternative arrangement, each of the alignment devices could merely comprise a guide rail, without any revolving guide elements. In such an arrangement, each guide rail would extend from the outer end of the docking assembly 121 to the inner end of the docking assembly 121 and would be arranged such that a guide surface of the guide rail contacts a side surface of the transport assembly 200 in order to guide the transport assembly 200 into the terminal 120. In such an arrangement, the guide rails may each comprise a low-friction guide surface that is arranged to contact a side surface of a transport assembly 200 when guiding the transport assembly 200 into the terminal 120. For example, each guide rail could comprise a contact section made from a hard-wearing, low friction material, such as nylon, polyoxymethylene (acetal), ultra-high molecular weight polyethylene (UHMW), polyethylene terephthalate (PET), polybutylene terephthalate (PBT), polyphenylene sulfide (PPS), polyether ether ketone (PEEK) etc.

In the illustrated arrangement, the alignment devices 122a, 122b, 123a, 123b are mounted to the floor within the terminal 120. In an alternative arrangement, the alignment devices 122a, 122b, 123a, 123b could be mounted to the structure of the terminal 120 rather than to the floor. In a yet further alternative arrangement, the alignment devices 122a, 122b, 123a, 123b could be rigidly suspended from the grid 103 above the terminal 120. Furthermore, whilst the illustrated arrangement shows the alignment devices 122a, 122b, 123a, 123b disposed towards the bottom of the terminal 120, in an alternative arrangement the alignment devices 122a, 122b, 123a, 123b could be disposed higher up the terminal 120, towards the top of the terminal 120.

In the arrangement illustrated in FIGS. 7a, 7b and 7c, the docking assembly 121 further comprises a releasable restraint device 128, 129, 130 that is arranged, when engaged, to hold a transport assembly 200 firmly within the terminal 120. The restraint device 128, 129, 130 is arranged to change from a disengaged configuration to an engaged configuration during movement of a transport assembly 200 into the docking assembly 121. The restraint device 128, 129, 130 is then arranged to change from the engaged configuration to the disengaged configuration in response to an operator request.

The restraint device 128, 129, 130 comprises a restraint member 128 and an actuator assembly 129, 130. The restraint member 128 is configured such that, when the restraint device 128, 129, 130 is in the engaged configuration, the restraint member 128 engages a transport assembly 200 that is disposed within the docking assembly 121 and holds the transport assembly 200 firmly within the terminal 120. The actuator assembly 129, 130 is then arranged to move the restraint member 128 in order to transition the restraint device 128, 129, 130 between the disengaged configuration and the engaged configuration. In particular, the actuator assembly 129, 130 is arranged to move the restraint member 129, 130 between an engaged position (i.e. when the restraint device 128, 129, 130 is in the engaged configuration) and a disengaged position (i.e. when the restraint device 128, 129, 130 is in the disengaged configuration).

In the illustrated arrangement, the restraint member 128 comprises a pusher that is arranged such that, when the restraint device 128, 129, 130 is in the engaged configuration, the pusher contacts a transport assembly 200 that is at least partially disposed within the docking assembly 121 and pushes the transport assembly 200 against an inner surface of the terminal 120. The actuator assembly 129, 130 then comprises a linkage assembly 129 that is connected to the restraint member 128 and an actuator motor 130 arranged to drive the linkage assembly 129. The linkage assembly 129 is arranged, when driven in a first direction by the actuator motor 130, to move the restraint member 128 from the disengaged position to the engaged position and, when driven in a second direction by the actuator motor 130, to move the restraint member 128 from the engaged position to the disengaged position. In the illustrated arrangement, the movement from the disengaged position to the engaged position involves both raising the restraint member 128 and moving the restraint member 128 towards the inner end of the docking assembly 121. Conversely, the movement from the engaged position to the disengaged position involves both moving the restraint member 128 away the inner end of the docking assembly 121 and lowering the restraint member 128. The raising and lowering of the restraint member 128 by the linkage assembly 129 provides that the restraint member 128 does not obstruct a transport assembly 200 when moving the transport assembly 200 into and out of the terminal 120.

In the arrangement illustrated in FIGS. 7a, 7b and 7c, the docking assembly 121 then further comprises a dock sensor 131 that is arranged to detect the presence of a transport assembly 200 at a position within the docking assembly 120. Detection of a transport assembly 200 within the docking assembly 121 may then be used to trigger actuation of the restraint device 128, 129, 130 to transition between the disengaged configuration and the engaged configuration. The dock sensor 131 may therefore be arranged to detect when the transport assembly 200 is within the range of operation of the restraint device 128, 129, 130. In particular, the dock sensor 131 may comprise a proximity sensor that is arranged to detect when the transport assembly 200 is within a predefined distance of an inner surface of the docking assembly 121. In the illustrated arrangement, the dock sensor 131 comprises a contact switch (e.g. a roller lever limit switch) that is arranged to be contacted by a transport assembly 200 when the transport assembly 200 is within a predefined distance of the inner surface of the docking assembly 121.

In the illustrated arrangement, the terminal 120 comprises a user-operable button 140 that is arranged to trigger the release of a transport assembly 200 from the terminal 120. In particular, actuation of the button 140 may be used to trigger actuation of the restraint device 128, 129, 130 to transition between the engaged configuration and the disengaged configuration. In an optional arrangement, the terminal 120 may further comprise a dock controller (not shown) that is configured to engage and disengage the restraint device 128, 129, 130 in response to inputs received from the dock sensor 131 and the button 140. In such an arrangement the dock controller may be configured to use additional inputs to determine when to engage or disengage the restraint device 128, 129, 130 such as inputs from safety sensors or systems.

As shown in FIG. 5, the terminal 120 further comprises a number of access channels 132. Each access channel 132 is disposed beneath a corresponding grid space 104 and is arranged to allow the load handling devices 110 to raise and lower storage containers 101 into the terminal 120. The alignment devices 122a, 122b, 123a, 123b of the docking assembly 121 are arranged to align the transport assembly 200 within the terminal 120 such that the one or more access channels 132 of the terminal 120 are aligned with container receiving portions 203 of the transport assembly 200.

In the illustrated arrangement, each access channel 132 comprises container guide elements 133 that are arranged to guide containers 101 into and out of the terminal 120, through the access channel 132. The alignment devices 122a, 122b, 123a, 123b are therefore arranged to align the transport assembly 200 relative to the container guide elements 133 of the terminal 120. In the illustrated arrangement, the container guide elements 133 of each access channel 132 are disposed at the periphery of the corresponding grid space 104 and extend downward towards the dock assembly 121. In particular, the container guide elements 133 of each access channel 132 are disposed adjacent to one or more corners of the corresponding grid spaces 104 and comprise a container guide rail that is arranged to channel a corresponding corner of a storage container 101 through the access channel 132.

In the illustrated arrangement, the container guide elements 133 each comprise a substantially vertical, elongate container guide rail having a substantially L-shaped cross section such that the corner of a storage container 101 can be positioned within the corner defined by the container guide rail. Each access channel 132 then comprises a space defined between the container guide elements 133 that is shaped to allow passage of a storage container 101.

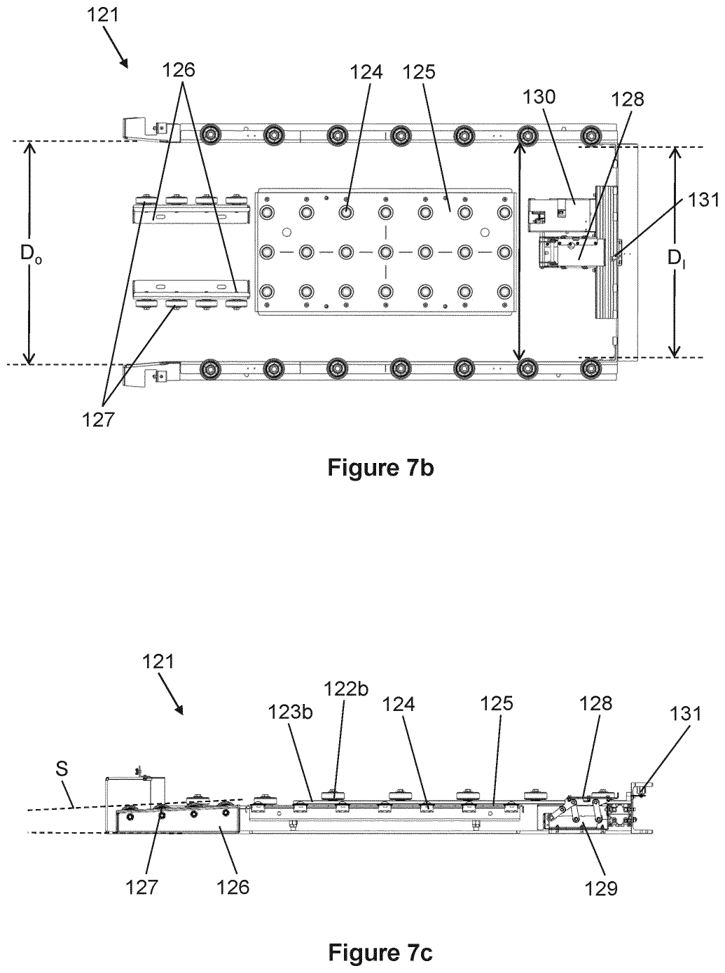

FIGS. 8a, 8b and 8c illustrate an example of a transport assembly 200 suitable for use with the terminal 120 of FIG. 5. In the illustrated arrangement, the transport assembly 200 comprises a body 201 mounted on movement means 202 that allow the transport assembly to move independently relative to the grid 103 and relative to the remaining stacks 102 of containers 101 within the workspace. The body 201 then comprises two receiving portions 203, each of the receiving portions 203 being configured to receive and retain a stack 102 of containers 101, and a base 204 that supports the receiving portions 203 and to which the movement means 202 are mounted. The base 204 of the transport assembly 200 then also comprises an under surface 205 that is arranged to contact the friction reducing surface 124, 125 of the docking assembly 121 when the transport assembly 200 is within the terminal 120 such that the transport assembly 200 is supported on the friction reducing surface 124, 125. The under surface 205 is preferably flat and smooth to ensure that the transport assembly 200 can be moved easily when the under surface 205 is in contact with the friction reducing surface 124, 125. When not within the terminal 120, the transport assembly 200 is supported by the movement means 202 on a floor surface in order to enable independent movement of the transport assembly 200. The terminal 120 is then arranged such that the movement means 202 of the transport assembly 200 do not touch the floor surface when the transport assembly 200 is supported on the friction reducing surface 124, 125.

In the arrangement illustrated in FIGS. 8a, 8b and 8c, the body 201 comprise a framework that defines the two receiving portions 203, with the framework attached to an upper surface of the base 204. Each receiving portion 203 comprises container receiving elements 206 that are arranged to guide containers 101 into and out of the receiving portion 203, and to restrain a stack 102 of containers 101 within the receiving portion 203. The alignment devices 122a, 122b, 123a, 123b of the terminal 120 are then arranged to align the transport assembly 200 such that the container receiving elements 206 of the each receiving portion 203 are aligned with container guide elements 133 of a corresponding access channel 132 of the terminal 120.

The receiving portions 203 of the transport assembly 200 then each comprise an access port 207 through which storage containers 101 can be inserted into and removed from the receiving portion 203. Each access port 207 comprises an opening at the top of the corresponding receiving portion 203 through which storage containers 101 can be lowered to and lifted away from a stack 102 of containers 101 within the receiving portion 203. The alignment devices 122a, 122b, 123a, 123b of the docking assembly 121 are arranged to align the transport assembly 200 within the terminal 120 such that each access channel 132 of the terminal 120 is aligned with a corresponding access port 207 of a receiving portion 203 of the transport assembly 200.

In the illustrated arrangement, the container receiving elements 206 of each receiving portion 203 are disposed at the periphery of the receiving portion 203 and extend downward towards the base 204. In particular, the container receiving elements 206 of each receiving portion 203 are disposed adjacent to one or more corners of the corresponding receiving portion 203 and comprise a container receiving rail that is arranged to guide containers 101 into and out of the receiving portion 203. In the illustrated arrangement, be the container receiving elements 206 each comprise a substantially vertical, elongate container receiving rail having a substantially L-shaped cross section such that the corner of a storage container 101 can positioned within the corner defined by the container receiving rail. The access port 207 of each receiving portion 203 then comprises a space defined between the upper ends of the container receiving elements 206 that is shaped to receive a storage container 101.

In the illustrated arrangement, the movement means 202 then comprise caster wheels that are mounted adjacent to each corner of the base 204. The base 204 then comprises a base plate that forms at least a portion of the under surface 205 that is arranged to contact the friction reducing surface 124, 125 of the terminal 120 when the transport assembly 200 is docked within the terminal 120.

In the arrangement illustrated in FIGS. 5, 6a, and 6b, the terminal 120 comprises a chamber that is arranged to receive a transport assembly 200 and within which the docking assembly 121 is located. The chamber therefore encloses the docking assembly 121 and any transport assembly 200 that is docked within the terminal 120 in order to improve the safety of the terminal 120.

In the illustrated arrangement, the terminal 120 comprises a framework 134 that defines the chamber and may optionally further comprise panels or cladding (not shown) mounted to the outside of the framework 134. The chamber then further comprises an opening through which a transport assembly 200 can move into and out of the terminal 120 and a door 136 that is arranged to cover the opening. The opening is arranged to be adjacent to the outer end of the docking assembly 121 such that a transport assembly 200 moving into the terminal 120 through the opening enters the docking assembly 121. The first side of the docking assembly 121 and the second side of the docking assembly 121 are therefore substantially perpendicular to the opening of the terminal 120. The inner surface of the terminal 120 against which the restraint member 128 holds the transport assembly 200 is then opposite the opening. The access channels 132 of the terminal 120 then each extend from beneath a corresponding grid space 104 to the interior of the chamber.

In the illustrated arrangement, the door 136 comprises a lock mechanism 137 that is configured to lock the door 136, thereby preventing access to the interior of the chamber. The terminal 120 then further comprises one or more lifting device sensors (not shown) that are configured to detect when the container-lifting device 114, 115 of a load handling device 110 is within the terminal 120, and a lock controller (not shown) that is configured to engage and disengage the lock mechanism in response to outputs from the lifting device sensors. In particular, the lock controller is configured to ensure that the locking mechanism 137 remains engaged when the container-engaging assembly 115 of a load handling device 110 is within the terminal 120, i.e. during the loading or unloading of containers 101 from a transport assembly 200 docked within the terminal 120. The lock controller may also be configured to ensure that the lock mechanism 137 is engaged prior to any load handling device 110 lowering a container-engaging assembly 115 into the terminal 120. To do so, the lock controller would be configured to communicate with the central control system that controls the load handling devices 110, and the central control system would then be configured to only allow a load handling device 110 to lower a container-engaging assembly 115 into the terminal 120 when informed by the lock controller that the locking mechanism 137 is engaged.

By way of example, the lifting device sensors could comprise one or more sensors disposed in each access channel 132 that are arranged to detect when the cables 114 of a container lifting device are present in the access channel 132, with the presence of the cables 114 within the access channel 132 indicating that the container engaging assembly 115 of a load handling device 110 is within the terminal 120. In such an arrangement, each lifting device sensor could comprise a photoelectric or ultrasonic sensor device that is positioned to detect a cable 114 in the access channel 132.

By way of further example, the lifting device sensors could comprise one or more sensors disposed in each access channel 132 that are arranged to detect a container lifting device passing through the access channel 132 and the direction of travel of the container lifting device. In such an arrangement, each lifting device sensor could comprise a pair of photoelectric or ultrasonic sensor devices positioned to detect a container lifting device passing through the access channel 132, with one sensor device disposed above the other. The order in which each sensor in the pair is activated would then be indicative of the direction of travel of a container lifting device through the access channel 132. Alternatively, each lifting device sensor could comprise a limit switch device, or contact proximity sensor device, that is positioned to detect a container lifting device passing through the access channel 132.

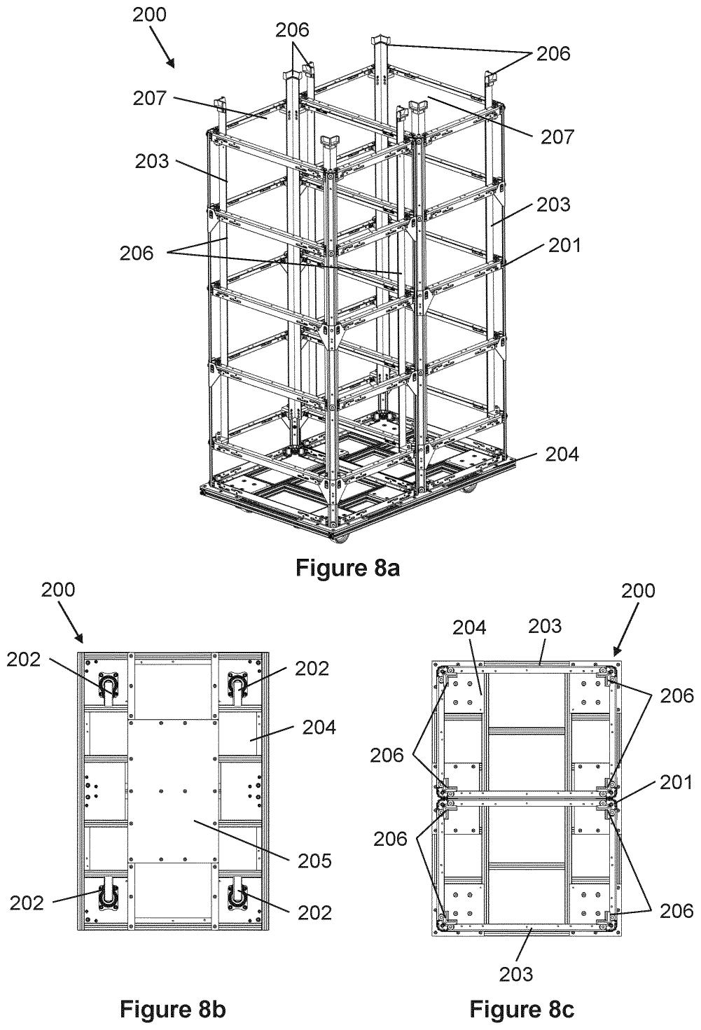

FIGS. 9a and 9b then illustrate an alternative arrangement in which the terminal 120 further comprises movable bridging elements 138 that are configured to move between a first position and a second position. When in the first position, the bridging elements 138 are arranged to extend at least partially between an access channel 132 of the terminal 120 and a receiving portion 203 of a transport assembly 200 that is disposed within the docking assembly 121. When in the second position, the bridging elements 138 are arranged to be retracted away from the second position. In doing so, the bridging elements 138 can at least partially bridge the gap between the terminal 120 and the transport assembly 200 when stacking and unstacking containers 101 from the transport assembly 200 and can then be retracted so that they do no obstruct movement of the transport assembly 200 into and out of the terminal 120. The bridging elements 138 are then arranged to guide storage containers 101 during movement between the access channel 132 of the terminal 120 and a receiving portion 203 of a transport assembly 200.

As shown in FIG. 9a, when in the first position the bridging elements 138 extend between a lower end of the access channel 132 and an upper end of the receiving portion 203 of a transport assembly 200 that is docked within the terminal 120. In particular, when in the first position, the bridging elements 138 are aligned with and extend between the guide elements 133 of the access channel 132 and the receiving elements 206 of the receiving portion 203. In the arrangement illustrated in FIGS. 9a and 9b, the bridging elements 138 are arranged to move laterally away from the first position to the second position (as shown in FIG. 9b). In doing so, bridging elements 138 move substantially horizontally relative to the access channel 132 and the receiving portion 203.

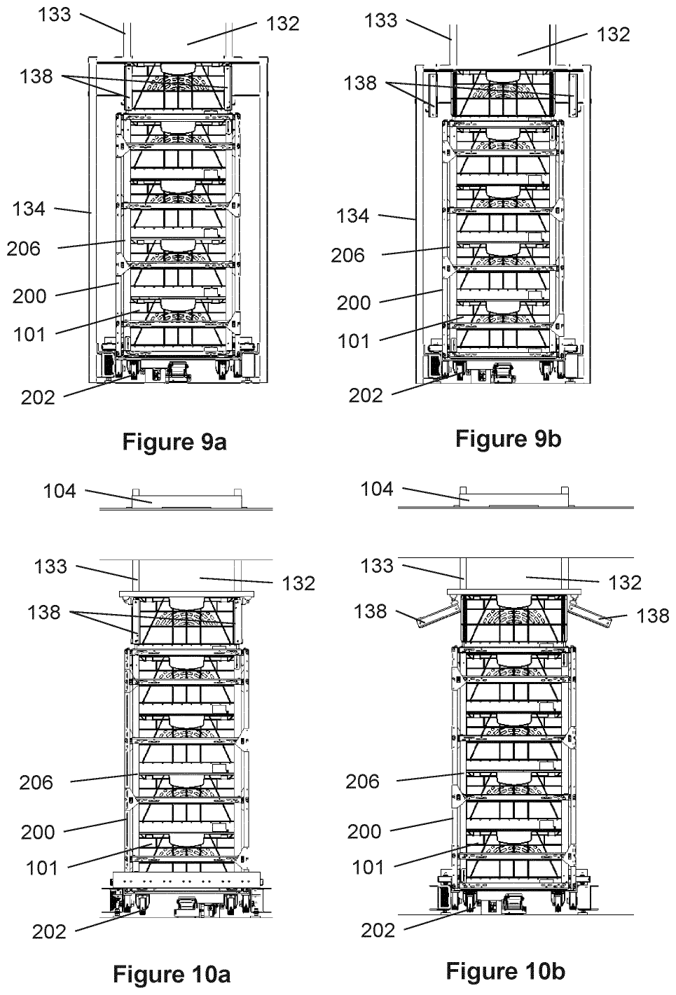

FIGS. 10a and 10b then illustrate a further alternative arrangement in which the terminal 120 further comprises movable bridging elements 138. In this arrangement, rather than being arranged to move laterally, the bridging elements 138 are arranged to pivot outwardly from the first position (as shown in FIG. 10a) to the second position (as shown in FIG. 10b). When in the first position, the bridging elements 138 are aligned with the substantially vertical guide elements 133 of the access channel 132 and the substantially vertical receiving elements 206 of the transport assembly 200, and are therefore also substantially vertical. The bridging elements 138 are then arranged to pivot outwardly, away from vertical and towards the horizontal, until they are in the second position.

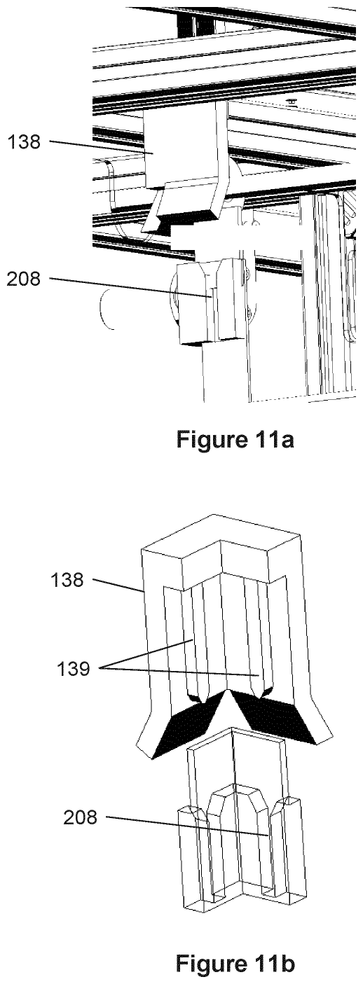

FIGS. 11a and 11b then illustrate a yet further alternative arrangement in which the terminal 120 further comprises movable bridging elements 138. In this arrangement, rather than being arranged to move laterally or pivotally, the bridging elements 138 are arranged to move vertically. In this arrangement, the bridging elements 138 are arranged, when in the first position, to engage with features of the transport assembly 200. The bridging elements 138 are then further arranged such that movement of the bridging elements 138 from the first position to the second position disengages the bridging elements 138 from the transport assembly 200. In a preferred arrangement, the bridging elements 138 each comprise one or more alignment features 139 that are each arranged to mate with a corresponding alignment feature 208 provided on the transport assembly 200. In the arrangement illustrated in FIGS. 11a and 11b, each of the alignment feature 138 of the bridging elements 138 comprises a substantially vertical, elongate projection, and the corresponding alignment features 208 on the transport assembly 200 then each comprise a substantially vertical, elongate slot that is arranged to receive a corresponding elongate projection of a bridging element 138.

It will be appreciated that the features described hereinabove may all be used together in a single system. In other embodiments of the invention, some of the features may be omitted. The features may be used in any compatible arrangement. Many variations and modifications not explicitly described above are possible without departing from the scope of the invention as defined in the appended claims.

It will be understood that the above description of is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the scope of this invention.

By way of example, in the above described arrangements, the transport assembly comprises movement means that allow the transport assembly to move independently relative to the grid and relative to the remaining stacks of containers within the workspace. However, in an alternative arrangement, the transport assembly may not itself comprise movement means but may be arranged to be carried by a separate transport vehicle having movement means. For example, the transport assembly could be arranged to be lifted and moved by a transport vehicle such as a forklift truck, pallet truck, automated guided vehicle (AGV), an autonomous mobile robot (AMR) etc. By way of further example, the system may further comprise a conveyor system arranged to convey the transport assembly to and from the terminal.

By way of further example, in the above described arrangements, the transport assembly comprises two receiving portions. However, in an alternative arrangement, each transport assembly could comprise a single receiving portion or could comprise more than two receiving portions (e.g. 3, 4 or more receiving portions).

1. A storage and retrieval system comprising:
a grid above a workspace;
a plurality of containers located in stacks within the workspace;
a plurality of load handling devices arranged to move along the grid and configured to raise and lower the containers to and from the stacks located within the workspace; and
a terminal disposed within the workspace, the terminal being arranged to receive a transport assembly that is configured to enable one or more of the stacks of containers to be transported away from the workspace;
wherein the terminal comprises a docking assembly that is arranged to control the position of the transport assembly within the terminal;
wherein the docking assembly comprises one or more alignment devices that are arranged to align the transport assembly relative to the grid above the terminal and a friction reducing surface that is arranged to support the transport assembly within the terminal.

2. The storage and retrieval system according to claim 1, wherein the terminal is arranged to allow the load handling devices to raise and lower the containers to and from the stacks located on the transport assembly when received within the terminal.

3. The storage and retrieval system according to claim 1, wherein the transport assembly comprises movement means that allow the transport assembly to move independently relative to the grid when supported by the movement means on a floor surface and wherein the terminal is arranged such that the movement means do not touch the floor surface when the tracks are supported on the friction reducing surface.

4. The storage and retrieval system according to claim 1, wherein the friction reducing surface comprises a multi-directional transfer surface, and preferably comprises a roller ball transfer surface.

5. The storage and retrieval system according to claim 1, wherein the terminal further comprises a releasable restraint device that is arranged, when engaged, to hold the transport assembly within the terminal.

6. The storage and retrieval system according to claim 5, wherein the restraint device is arranged to transition from a disengaged configuration to an engaged configuration during movement of a transport assembly into the docking assembly.

7. The storage and retrieval system according to claim 5, wherein the terminal further comprises a sensor that is arranged to detect the presence of a transport assembly within the terminal, and the restraint device is arranged to transition from the disengaged configuration to the engaged configuration in response to an input from the sensor.

8. The storage and retrieval system according to claim 5, wherein the restraint device is arranged to hold the transport assembly against an inner surface of the terminal when in the engaged configuration.

9. The storage and retrieval system according to claim 8, wherein the terminal comprises an opening arranged to allow the transport assembly to move into and out of the terminal and the inner surface of the terminal is opposite to the opening.

10. The storage and retrieval system according to claim 9, wherein the restraint device is further arranged to move the transport assembly towards an inner surface of the terminal.

11. The storage and retrieval system according to claim 1, wherein the grid defines a plurality of grid spaces and each stack of containers is disposed beneath a grid space, and the terminal comprises one or more access channels, each access channel being disposed beneath a corresponding grid space and being arranged to allow the load handling devices to raise and lower storage containers into the terminal.

12. The storage and retrieval system according to claim 11, wherein the alignment devices of the docking assembly are arranged to align the transport assembly within the terminal such that the one or more access channels of the terminal are aligned with container receiving portions of the transport assembly.

13. The storage and retrieval system according to claim 11, wherein each access channel comprises container guide elements that are arranged to guide containers into and out of the terminal through the access channel.

14. The storage and retrieval system according to claim 1, wherein the terminal comprises a chamber that is arranged to receive a transport assembly and within which the docking assembly is located, and the chamber comprises an opening through which a transport assembly can move into and out of the terminal and a door that is arranged to cover the opening.

15. The storage and retrieval system according to claim 14, wherein terminal comprises:
a lock mechanism that is configured to lock the door;
one or more sensors that are configured to detect when a container-lifting device of a load handling device is within the terminal; and
a lock controller that is configured to engage and disengage the lock mechanism in response to outputs from the sensors.

16. The storage and retrieval system according to claim 1, wherein the terminal further comprises movable bridging elements that are configured to move between a first position and a second position, wherein the bridging elements are arranged, when in the first position, to extend at least partially between an access channel of the terminal and a receiving portion of a transport assembly that is disposed within the terminal and, when in the second position, to be retracted away from the first position.

17. The storage and retrieval system according to claim 16, wherein the bridging elements are arranged to guide storage containers during movement between the access channel of the terminal and a receiving portion of a transport assembly.

18. The storage and retrieval system according to claim 1, wherein the docking assembly further comprises a ramp device arranged to raise a transport assembly on to the friction reducing surface during movement of the transport assembly into the docking assembly.

19. The storage and retrieval system according to claim 18, wherein the ramp device comprises one or more rolling elements that are arranged to contact an under surface of the transport assembly during movement of the transport assembly into and out of the docking assembly and to cause the transport assembly to rise up as the transport assembly moves into the docking assembly.

20. The storage and retrieval system according to claim 19, wherein the rolling elements are arranged such that the uppermost surface of the rolling elements define a slope suitable to cause a transport assembly to rise up or descend when rolling over the rolling elements.

21. The storage and retrieval system according to claim 20, wherein the transport assembly comprises a base and a body supported on the base, the body comprising one or more receiving portions, each of the receiving portions being configured to receive and retain a stack of containers.

22. The storage and retrieval system according to claim 21, wherein the base of the transport assembly comprises an under surface that is arranged to contact the friction reducing surface of the docking assembly when the transport assembly is within the terminal such that the transport assembly is supported on the friction reducing surface.

23. The storage and retrieval system according to claim 21, wherein the or each receiving portion comprises container receiving elements that are arranged to guide containers into and out of the receiving portion and to restrain a stack of containers within the receiving portion.

24. The storage and retrieval system according to claim 21, wherein the or each receiving portion comprises an access port through which storage containers are inserted into and removed from the receiving portion.

25. A transport assembly that is configured to enable one or more stacks of containers to be transported, the transport assembly comprising:
a base and a body supported on the base, the body comprising one or more receiving portions, each of the receiving portions being configured to receive and retain a stack of containers.

26. A storage and retrieval system comprising:
a grid above a workspace;
a plurality of containers located in stacks within the workspace;
a plurality of load handling devices arranged to move along the grid and configured to raise and lower the containers to and from the stacks located within the workspace; and
a terminal disposed within the workspace, the terminal being arranged to receive a transport assembly that is configured to enable one or more of the stacks of containers to be transported away from the workspace;
wherein the terminal comprises:
a docking assembly that is arranged to control the position of the transport assembly within the terminal; and
a chamber that is arranged to receive a transport assembly and within which the docking assembly is located;
wherein the chamber comprises an opening through which a transport assembly can move into and out of the terminal, a door that is arranged to cover the opening, a lock mechanism that is configured to lock the door, one or more sensors that are configured to detect when a container-lifting device of a load handling device is within the terminal, and a lock controller that is configured to engage and disengage the lock mechanism in response to outputs from the sensors.

27. A storage and retrieval system comprising:
a grid above a workspace;
a plurality of containers located in stacks within the workspace;
a plurality of load handling devices arranged to move along the grid and configured to raise and lower the containers to and from the stacks located within the workspace;
a terminal disposed within the workspace, the terminal being arranged to receive a transport assembly that is configured to enable one or more of the stacks of containers to be transported away from the workspace;
wherein the terminal comprises:
a docking assembly that is arranged to control the position of the transport assembly within the terminal; and
one or more movable bridging elements that are configured to move between a first position and a second position, wherein the bridging elements are arranged, when in the first position, to extend at least partially between an access channel of the terminal and a receiving portion of a transport assembly that is disposed within the terminal and, when in the second position, to be retracted away from the first position.
